(19) United States
(12) Patent Application Publication
(10) Pub. No.: US 2014/0003788 A1
(43) Pub. Date: Jan. 2, 2014

(54) CONTENT PLAYBACK SYSTEM, ELECTRONIC APPARATUS, AND CONTENT PLAYBACK METHOD

(71) Applicant: KABUSHIKI KAISHA TOSHIBA, Tokyo (JP)

(72) Inventors: Kosuke Uchida, Higashimurayama-shi (JP); Seiichi Nakamura, Inagi-shi (JP)

(73) Assignee: KABUSHIKI KAISHA TOSHIBA, Tokyo (JP)

(21) Appl. No.: 13/972,073

(22) Filed: Aug. 21, 2013

Related U.S. Application Data
(63) Continuation of application No. PCT/JP2013/057938, filed on Mar. 13, 2013.

(30) Foreign Application Priority Data
Jun. 27, 2012 (JP) 2012-144026

(51) Int. Cl. H04N 9/87

(52) U.S. Cl. CPC H04N 9/87
USPC 386/230

(57) ABSTRACT

According to one embodiment, a content playback system includes a first electronic apparatus including a first drive and a second electronic apparatus including a second drive. The first electronic apparatus includes a content transmitter. The content transmitter is configured to transmit content read from a storage medium by the first drive to the second electronic apparatus. The second electronic apparatus includes a remote content reproducer. The remote content reproducer is configured to play back the content transmitted from the first electronic apparatus using a content reproducer configured to play back content read from a storage medium by the second drive.

### CROSS-REFERENCE TO RELATED APPLICATIONS

This application is a Continuation Application of PCT Application No. PCT/JP2013/057938, filed Mar. 13, 2013 and based upon and claiming the benefit of priority from Japanese Patent Application No. 2012-144026, filed Jun. 27, 2012, the entire contents of all of which are incorporated herein by reference.

### FIELD

Embodiments described herein relate generally to a content playback system, electronic apparatus, and content playback method, which play back content stored in a portable storage medium (for example, a Blu-ray Disc (to be referred to as “BD” hereinafter), DVD (Digital Versatile Disc), or the like).

### BACKGROUND

In recent years, portable electronic apparatuses such as notebook computers, which can be powered by batteries, have prevailed. Some electronic apparatuses of this type incorporate a drive (BD/DVD drive) for executing read/write data accesses to a BD or DVD, and include an audiovisual (AV) function of playing back content read from the BD or DVD by the drive.

Recently, a home network in which a high performance computer called a home server or the like integrally manages content such as television broadcast program data, and the user can request the home server to play back content from television receivers and computers in arbitrary rooms and can appreciate the content is established in many homes.

Upon appreciating content stored in a BD or DVD, it is inconvenient for the user to set a BD or DVD in a BD/DVD drive. For example, since a television receiver (which incorporates a BD/DVD drive) is normally remote controlled using a remote controller, it is troublesome for the user to set a BD or DVD in the BD/DVD drive from this point.

On the other hand, some portable electronic apparatuses such as notebook computers, which can be powered by batteries, incorporate a BD/DVD drive. However, except for electronic apparatuses of high grade models, which allow users to enjoy video and music content with high quality, it is very much a situation in which use frequencies of such electronic apparatuses for the purpose of appreciating content stored in BDs or DVDs are not so high.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing an example of the configuration of a content playback system according to the first embodiment.

FIG. 2 is an exemplary block diagram showing functional blocks of the content playback system according to the first embodiment.

FIG. 3 is an exemplary flowchart showing the operation sequence on the computer side of the content playback system according to the first embodiment.

FIG. 4 is an exemplary flowchart showing the operation sequence on the TV apparatus side of the content playback system according to the first embodiment.

FIG. 5 is an exemplary view showing an example of the configuration of a content playback system according to the second embodiment.

FIG. 6 is an exemplary block diagram showing functional blocks of the content playback system according to the second embodiment.

FIG. 7 is an exemplary flowchart showing the operation sequence on the TV apparatus side of the content playback system according to the second embodiment.

### DETAILED DESCRIPTION

Various embodiments will be described hereinafter with reference to the accompanying drawings.

In general, according to one embodiment, a content playback system includes a first electronic apparatus and a second electronic apparatus. The first electronic apparatus includes a first drive. The second electronic apparatus includes a second drive and is configured to connect to the first electronic apparatus. The first electronic apparatus includes a content transmitter. The content transmitter is configured to transmit content read from a storage medium by the first drive to the second electronic apparatus. The second electronic apparatus includes a remote content reproducer. The remote content reproducer is configured to play back the content transmitted from the first electronic apparatus using a content reproducer configured to play back content read from a storage medium by the second drive.

### First Embodiment

The first embodiment will be described first.

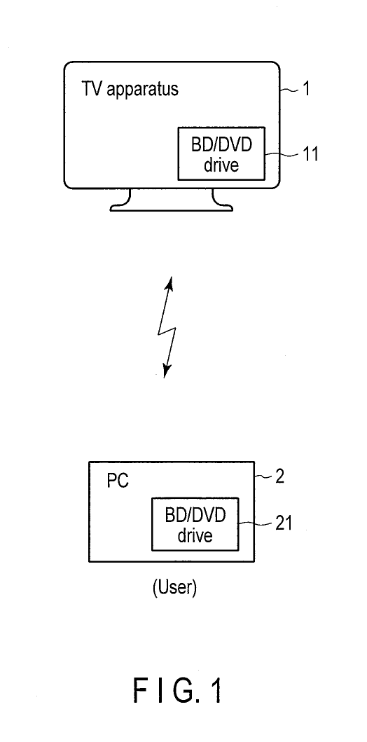

FIG. 1 is an exemplary view showing an example of the configuration of a content playback system of this embodiment.

As shown in FIG. 1, the content playback system of this embodiment includes a television (TV) apparatus 1 and computer 2. The TV apparatus 1 and computer 2 respectively incorporate BD/DVD drives 11 and 21, and respectively include a function of playing back content read from a BD or DVD. That is, both the TV apparatus 1 and computer 2 can operate as BD/DVD players. Therefore, the user can appreciate content stored in a BD or DVD using the TV apparatus 1 and the computer 2. Furthermore, the TV apparatus 1 and computer 2 respectively include a wireless communication function, and can exchange various data between them.

Now assume that the computer 2 is a notebook computer, which can be powered by a battery, and is placed in the vicinity of the user. On the other hand, assume that the TV apparatus 1 is a television receiver including a large screen display device, and is placed at a relatively distant place from the user.

In this situation, assume that the user wants to appreciate content in a BD set in the BD/DVD drive 21 of the computer 2 on the large screen of the TV apparatus 1. In this case, the user has to remove that BD from the BD/DVD drive 21 of the computer 2, and to set again that BD in the BD/DVD drive 11 of the TV apparatus 1 placed at the relatively distant place.

Also, when the user wants to appreciate content in a BD in hand on the large screen of the TV apparatus 1, he or she has to set the BD in the BD/DVD drive 11 of the TV apparatus 1 placed at the relatively distant place in place of the BD/DVD drive 21 of the computer 2 placed in the vicinity.

Hence, the content playback system of this embodiment includes a mechanism which reads content in a BD or DVD using the BD/DVD drive 21 on the computer 2 side, and plays back the read content using a playback function (which is originally used to play back content read by the BD/DVD drive 11) on the TV apparatus 1 side. This mechanism will be described in detail below.

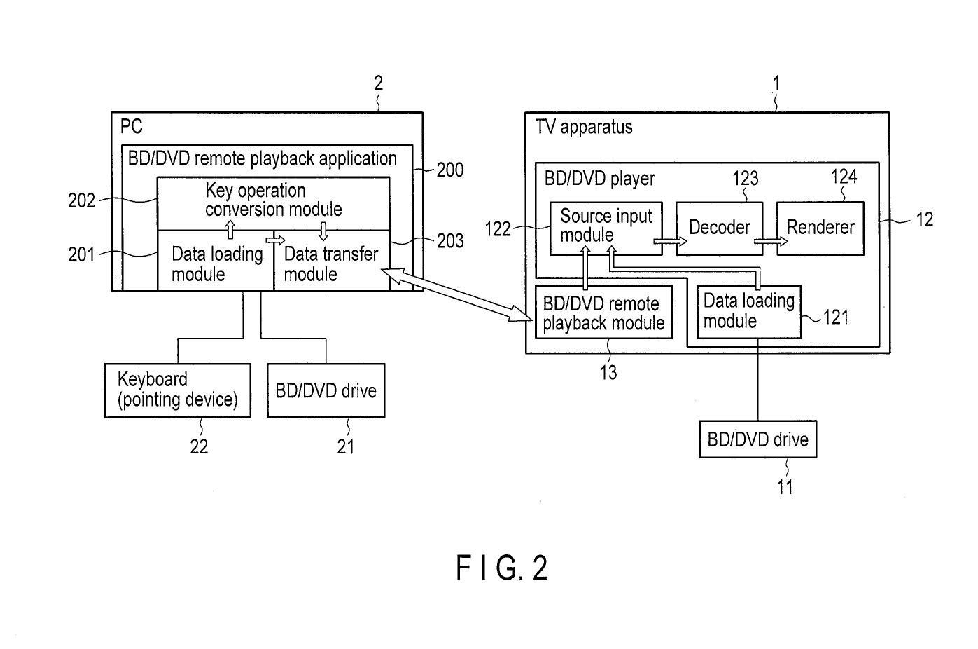

FIG. 2 is an exemplary block diagram showing functional blocks of the content playback system of this embodiment.

As shown in FIG. 2, a BD/DVD remote playback application 200 runs on the computer 2. The BD/DVD remote playback application 200 is a program used to allow the user to appreciate content in a BD or DVD set in the BD/DVD drive 21 on the TV apparatus 1, and is, for example, software, which is loaded from a hard disk drive (HDD) into a main memory and is executed by a CPU. Note that the BD/DVD remote playback application 200 may be provided independently of software used to appreciate content in a BD or DVD set in the BD/DVD drive 21 on the computer 2, or may be provided as one sub module of this software.

The BD/DVD remote playback application 200 includes a data loading module 201, key operation conversion module 202, and data transfer module 203. The data loading module 201 is a module required to fetch content in a BD or DVD via the BD/DVD drive 21, and also to fetch a user instruction associated with content playback via a keyboard (pointing device) 22.

The user instruction associated with content playback is fetched by the data loading module 201 as input data from the keyboard 22. The key operation conversion module 202 is a module required to convert this input data into an operation code required to issue an operation instruction to a BD/DVD player 12 (to be described later) on the TV apparatus 1 side.

The data transfer module 203 is a module required to transfer the content fetched by the data loading module 201 or the operation code generated by the key operation conversion module 202 to the TV apparatus 1 (via the wireless communication function included in the computer 2).

On the other hand, the TV apparatus 1 includes the BD/DVD player 12 and a BD/DVD remote playback module (reproducer) 13. The BD/DVD player 12 is a module required to play back content in a BD or DVD set in the BD/DVD drive 11, and the BD/DVD remote playback module 13 plays back the content transferred from the computer 2 using the BD/DVD player 12 (which is originally used to play back content in a BD or DVD set in the BD/DVD drive 11).

The BD/DVD player 12 includes a data loading module 121, source input module 122, decoder 123, and renderer 124.

The data loading module 121 is a module required to fetch content in a BD or DVD via the BD/DVD drive 11. Note that the data loading module 121 also includes a function of fetching an instruction input by the user on the TV apparatus 1 in association with content playback.

The source input module 122 is a module required to receive content from the data loading module 121 or BD/DVD remote playback module 13, and to supply the received content to the decoder 123. The decoder 123 is a module required to decode the content supplied from the source input module 122. The renderer 124 is a module required to render and display images of the content decoded by the decoder 123.

The BD/DVD remote playback application 200 executes connection processing with the TV apparatus 1, which is registered in advance as a remote BD/DVD player, when it is activated. After the connection is established with the TV apparatus 1, the BD/DVD remote playback application 200 starts content read processing using the BD/DVD drive 21. After that, the BD/DVD remote playback application 200 executes the content read processing in cooperation with the TV apparatus 1 side.

More specifically, the BD/DVD remote playback module 13 of the TV apparatus 1 supplies content transferred from the computer 2 to the BD/DVD player 12 while temporarily storing it in a buffer. The BD/DVD remote playback module 13 requests the computer 2 side as needed to transfer the content so that the amount of the content stored in the buffer falls within an appropriate range. That is, the BD/DVD remote playback application 200 executes the content read processing in accordance with the request from the TV apparatus 1 side.

On the other hand, after the TV apparatus 1 is connected to the computer 2, the BD/DVD player 12 sets the BD/DVD remote playback module 13 as a content supply source, and then starts content playback processing. As a result, for example, the user can set a BD or DVD in the BD/DVD drive 21 of the computer 2 placed in the vicinity, and can appreciate content in that BD or DVD on the TV apparatus 1 placed at the relatively distant place.

Unlike in a case in which content read from the BD/DVD drive 21 is played back on the computer 2 side, and the played back content is transferred to the TV apparatus 1, the content playback processing can be stabilized using the content playback mechanism on the TV apparatus 1 side. Since the computer 2 has various use applications, and an operating system which controls resource management of the computer 2 provides a multitasking function, another program may run parallel to the content playback processing.

When the content is played back on the computer 2 side, for example, frame drops may occur depending on a load of the other program, thus disturbing content appreciation. In contrast, the content playback system of this embodiment obviates the need for content playback processing on the computer 2 side to suppress occurrence of any frame drops, thus allowing the user to appreciate content with comfort.

When a display device included in the computer 2 is inexpensive one, a refresh rate may often be different from a proper value. When a refresh rate is not correct, frame drops readily occur due to display timing errors. In such case, the content playback system of this embodiment uses the TV apparatus 1 (while using the computer 2 to read content), thus allowing the user to appreciate the content with comfort. Furthermore, use frequencies of the BD/DVD drive 21 of this computer 2 for the purpose of appreciating content stored in a BD or DVD can be increased.

When an instruction associated with content playback is input from the keyboard 22, the BD/DVD remote playback application 200 generates an operation code of the BD/DVD player 12, and transfers it to the TV apparatus 1 side. The BD/DVD remote playback module 13 supplies the operation code transferred from the computer 2 side to the BD/DVD player 12. Thus, the user can make various operations on the computer 2 placed in the vicinity upon appreciating the content on the TV apparatus 1.

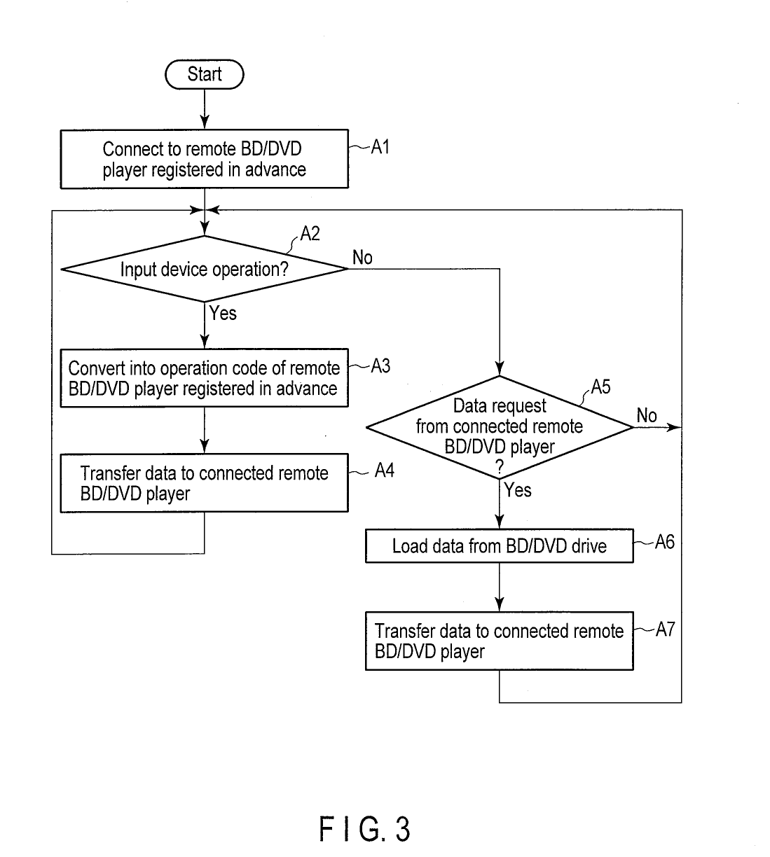

FIG. 3 is an exemplary flowchart showing the operation sequence on the computer 2 side of the content playback system of this embodiment.

The BD/DVD remote playback application 200 establishes a connection to a remote BD/DVD player (TV apparatus 1 in this case), which is registered in advance, when it is activated (block A1). The BD/DVD remote playback application 200 checks whether or not the user has made an operation of an input device (keyboard 22 in this case) (block A2). If the user has made an operation of the input device (YES in block A2), the BD/DVD remote playback application 200 converts input data from the input device into an operation code of the remote BD/DVD player, which is registered in advance (block A3), and transfers the operation code to the remote BD/DVD player (connected in block A1), which is registered in advance (block A4).

If the user has not operated the input device (NO in block A2), the BD/DVD remote playback application 200 checks whether or not a data request is received from the connected remote BD/DVD player (block A5). If the data request is received from the remote BD/DVD player (YES in block A5), the BD/DVD remote playback application 200 executes content read processing using the BD/DVD drive 21 (block A6), and transfers the read content to the connected remote BD/DVD player (block A7).

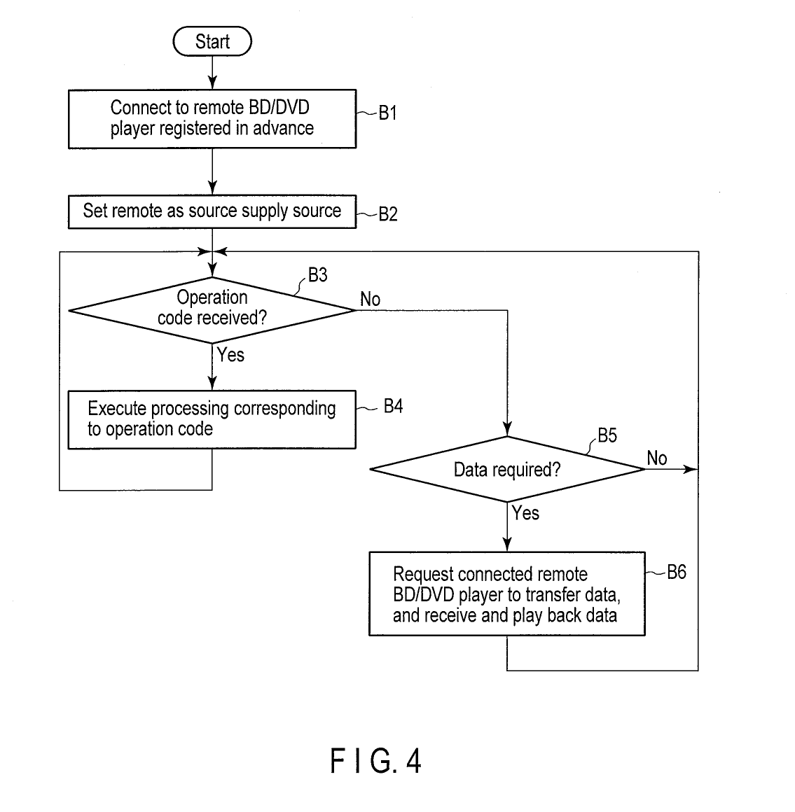

FIG. 4 is an exemplary flowchart showing the operation sequence on the TV apparatus 1 side of the content playback system of this embodiment.

When the TV apparatus 1 is connected to a remote BD/DVD player (PC 2 in this case), which is registered in advance, in response to a request from that remote BD/DVD player (block B1), the BD/DVD player 12 sets the remote BD/DVD player as a content supply source (block B2). The BD/DVD remote playback module 13 checks whether or not an operation code is transferred from the remote BD/DVD player (block B3). If the operation code is transferred (YES in block B3), the BD/DVD remote playback module 13 supplies that operation code to the BD/DVD player 12. The BD/DVD player 12 executes processing corresponding to the supplied operation code (block B4).

If no operation code is transferred, the BD/DVD remote playback module 13 checks based on a buffer state whether or not content is required (block B5). If the content is required (YES in block B5), the BD/DVD remote playback module 13 sends a data request to the computer 2 side (block B6). The BD/DVD remote playback module 13 supplies content transferred from the computer 2 side to the BD/DVD player 12, and the BD/DVD player 12 plays back the supplied content.

As described above, according to the content playback system of this embodiment, effective use of resources of a plurality of electronic apparatuses (TV apparatus 1 and computer 2) which respectively incorporate drives can be promoted, and the convenience can be improved.

### Second Embodiment

The second embodiment will be described below.

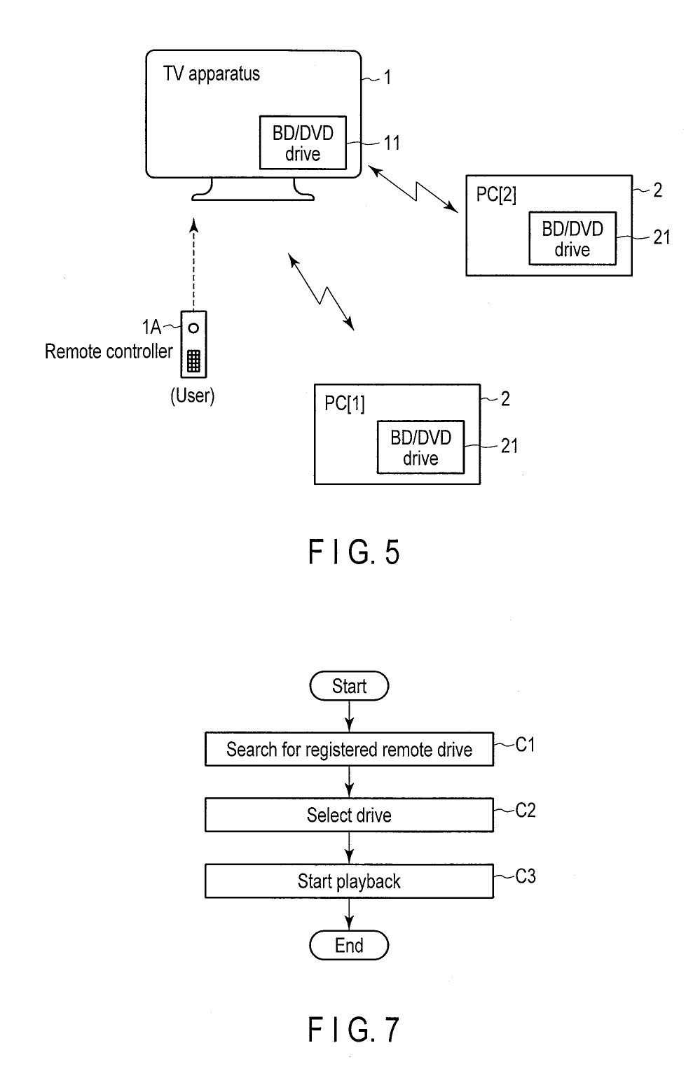

FIG. 5 is an exemplary view showing an example of the configuration of a content playback system of this embodiment.

In the aforementioned content playback system of the first embodiment, when the BD/DVD remote playback application 200 is activated on the computer 2, the computer 2 and TV apparatus 1 are connected, and content in a BD or DVD set in the BD/DVD drive 21 of the computer 2 is played back on the TV apparatus 1. In contrast, in the content playback system of this embodiment, in consideration of a remote controller 1A for remote control which generally comes with the TV apparatus 1, content in a BD or DVD set in the BD/DVD drive 21 of the computer 2 is allowed to be played back on the TV apparatus 1 by an operation on the TV apparatus 1 side.

For example, assuming that two computers 2 each incorporating the BD/DVD drive 21 exist around the TV apparatus 1 as shown in FIG. 5, the TV apparatus 1 provides an interface which prompts the user to select one of a total of three BD/DVD drives 11 and 21 including the BD/DVD drive 11 incorporated in the self apparatus (TV apparatus 1) and the two BD/DVD drives 21 incorporated in the computers 2.

When the user selects the BD/DVD drive 21 of the computer 2, the TV apparatus 1 requests the computer 2 incorporating the selected BD/DVD drive 21 to transfer content. That is, in the content playback system of this embodiment, the user sets a BD or DVD in the BD/DVD drive 21 of the computer 2 placed in the vicinity, and makes an operation for selecting this BD/DVD drive 21 using the remote controller 1A of the TV apparatus 1, so that he or she can appreciate content in that BD or DVD on the large screen of the TV apparatus 1 (placed at a distant place).

Even if a display device included in the computer 2 is inexpensive one, and a refresh rate is not correct, content playback processing is executed on the TV apparatus 1 side, and the user can appreciate content with comfort.

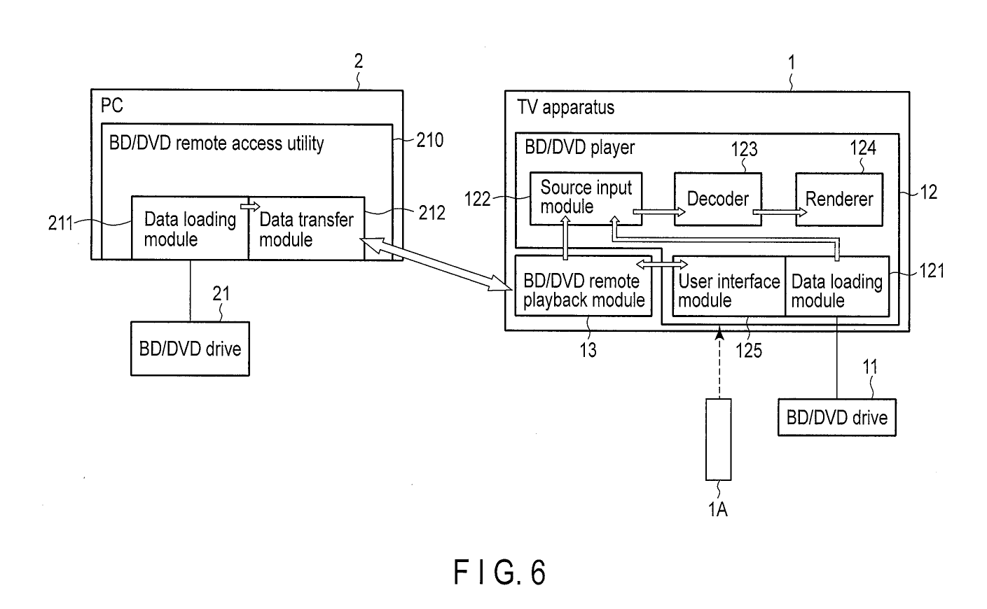

FIG. 6 is an exemplary block diagram showing functional blocks of the content playback system of this embodiment.

As shown in FIG. 6, in the content playback system of this embodiment, the BD/DVD player 12 included in the TV apparatus 1 includes a user interface module 125 used to accept user instructions associated with content playback. On the other hand, a BD/DVD remote access utility 210 used to support a remote access of the TV apparatus 1 to the BD/DVD drive 21 runs on the computer 2. The BD/DVD remote access utility 210 is software, which is loaded from, for example, an HDD into a main memory, and is executed by a CPU, and is set as a resident program.

The BD/DVD player 12 instructs the BD/DVD remote playback module 13 to search for remote BD/DVD drives which exist around the TV apparatus 1, when it is activated. Upon reception of this instruction, the BD/DVD remote playback module 13 searches for the computers 2 which are registered in advance as remote BD/DVD players, and returns the search result to the BD/DVD player 12. The user interface module 125 of the BD/DVD player 12 presents, to the user, the BD/DVD drive 11 incorporated in the TV apparatus 1 and the BD/DVD drives 21 of the computers 2 detected by the BD/DVD remote playback module 13 as choices.

Now assume that the user wants to set a BD or DVD in the BD/DVD drive 21 of the computer 2 placed in the vicinity, and to appreciate content in this BD or DVD on the large screen of the TV apparatus 1. In this case, the user selects the BD/DVD drive 21 of the computer 2 placed in the vicinity from the plurality of BD/DVD drives 11 and 21 presented by the user interface module 125 as choices. The user inputs this instruction using, for example, the remote controller 1A.

Upon reception of this selection instruction via the user interface module 125, the BD/DVD player 12 instructs the BD/DVD remote playback module 13 to request the computer 2 incorporating the selected BD/DVD drive 21 to transfer content. Also, at this time, the BD/DVD player 12 causes the source input module 122 to set the BD/DVD remote playback module 13 as a content supply source.

On the other hand, the BD/DVD remote access utility 210, which runs on the computer 2, accepts this request via a data transfer module 212, and starts read processing of content in the BD or DVD set in the BD/DVD drive 21 using a data loading module 211. The data transfer module 212 transfers the read content to the TV apparatus 1, and the BD/DVD remote playback module 13 of the TV apparatus 1 supplies the content transferred from the computer 2 to the BD/DVD player 12.

FIG. 7 is an exemplary flowchart showing the operation sequence on the TV apparatus 1 side of the content playback system of this embodiment.

The BD/DVD player 12 instructs the BD/DVD remote playback module 13 to search for remote BD/DVD drives when it is activated (block C1). Upon reception of this instruction, the BD/DVD remote playback module 13 searches for the computers 2, which are registered in advance as remote BD/DVD players.

The BD/DVD player 12 presents, as choices, the BD/DVD drive 11 incorporated in the TV apparatus 1 and the BD/DVD drives 21 incorporated in the computers 2 detected by the BD/DVD remote playback module 13, and prompts the user to select one of these BD/DVD drives (block C2).

Then, the BD/DVD player 12 starts read processing of content using the selected BD/DVD drive (block C3), and executes playback processing of the read content. When the BD/DVD drive 21 other than the BD/DVD drive 11 incorporated in the TV apparatus 1 is selected, the BD/DVD player 12 instructs the BD/DVD remote playback module 13 to request the computer 2 which incorporates the selected BD/DVD drive 21 to transfer content.

As described above, according to the content playback system of this embodiment as well, effective use of resources of a plurality of electronic apparatuses (TV apparatus 1 and computers 2) which respectively incorporate drives can be promoted, and the convenience can be improved.

Note that operation control processing of each embodiment can be implemented by software (program). By installing this software in a normal computer via a computer readable storage medium, which stores this software, and executing the installed software, the same effects as in the above embodiments can be easily attained.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content playback system comprising:
a first electronic apparatus comprising a first drive; and
a second electronic apparatus comprising a second drive, the second electronic apparatus configured to connect to the first electronic apparatus, wherein:
the first electronic apparatus comprises a content transmitter configured to transmit content read from a storage medium by the first drive to the second electronic apparatus; and
the second electronic apparatus comprises a remote content reproducer configured to play back the content transmitted from the first electronic apparatus using a content reproducer configured to play back content read from a storage medium by the second drive.

2. The system of claim 1, wherein the first electronic apparatus further comprises an operation code transmitter configured to convert input data from an input device into an operation code of the content reproducer and to transmit the operation code to the second electronic apparatus.

3. The system of claim 1, wherein the second electronic apparatus further comprises:
a user interface configured to accept an instruction associated with content playback; and
a remote access configured to request the first electronic apparatus to transmit the content by the content transfer, when the user interface accepts a playback instruction of content stored in a storage medium in the first drive.

4. An electronic apparatus comprising:
a drive configured to read content stored in a storage medium;
a content reproducer configured to play back the content read from the storage medium by the drive;
a communicator; and
a remote content reproducer configured to play back content received by the communicator using the content reproducer.

5. The apparatus of claim 4, further comprising an operation code receptor configured to supply an operation code of the content reproducer received by the communicator to the content reproducer.

6. An electronic apparatus comprising:
a user interface configured to accept an instruction associated with content playback; and
a remote access configured to request a first electronic apparatus to transmit content stored in a storage medium in a drive in the first electronic apparatus, when the user interface accepts a playback instruction of content stored in the storage medium in the drive in the first electronic apparatus configured to communicate with a communicator.

7. A content playback method of a content playback system in which a first electronic apparatus comprising a first drive and a second electronic apparatus comprising a second drive are configured to be connected, the method comprising:
transmitting, by the first electronic apparatus, content read from a storage medium by the first drive to the second electronic apparatus; and
playing back, by the second electronic apparatus, the content transmitted from the first electronic apparatus using a content reproducer configured to play back content read from a storage medium by the second drive.

8. The method of claim 7, further comprising
converting, by the first electronic apparatus, input data from an input device into an operation code of the content reproducer, and
transmitting the operation code to the second electronic apparatus.

9. The method of claim 7, further comprising:
accepting, by the second electronic apparatus, an instruction associated with content playback; and
requesting, by the second electronic apparatus, the first electronic apparatus to transmit the content, when a playback instruction of content stored in a storage medium in the first drive is accepted.
